(19) United States
(12) Patent Application Publication
(10) Pub. No.: US 2025/0094355 A1
(43) Pub. Date: Mar. 20, 2025

(54) Translation Lookaside Buffer Entry Locking

(71) Applicant: Apple Inc., Cupertino, CA (US)

(72) Inventors: Brett S. Feero, Lake Oswego, OR (US); Brian T. Mokrzycki, Portland, OR (US); Jonathan Y. Tong, Austin, TX (US); Michael D. Snyder, Cedar Park, TX (US); James N. Hardage, Austin, TX (US)

(21) Appl. No.: 18/544,110

(22) Filed: Dec. 18, 2023

Related U.S. Application Data
(60) Provisional application No. 63/583,471, filed on Sep. 18, 2023.

(51) Int. Cl. G06F 12/1027

(52) U.S. Cl. CPC G06F 12/1027; G06F 2212/68

(57) ABSTRACT

Techniques are disclosed relating to using an instruction (e.g., a pre-translate instruction) to lock translations in TLB entries. The execution of the instruction may include storing translation information in a TLB entry, and setting an indication that the entry is locked. The processor circuitry may receive an invalidate command corresponding to the locked entry. Processor circuitry may, in response to the invalidate command and based on the indication that the entry is locked, maintain the locked entry in a valid state in the translation lookaside buffer circuitry, notwithstanding the invalidate command. Processor circuitry may be further configured to modify previously-stored data in a given entry to aggregate, in the entry, translation information for multiple regions of the second address space.

### PRIORITY CLAIM

The present application claims priority to U.S. Provisional App. No. 63/583,471, entitled “Translation Lookaside Buffer Entry Locking,” filed Sep. 18, 2023, the disclosure of which is incorporated by reference herein in its entirety.

### BACKGROUND

### Technical Field

This disclosure relates generally to computer processors, and, more specifically, to locking an entry of a translation lookaside buffer.

### Description of the Related Art

The Translation Lookaside Buffer (TLB) is a hardware component often found in modern CPUs. The TLB may speed up memory access by providing a cache for frequently-used translations from a source address space (e.g., a virtual address space) to a destination address space (e.g., a physical address space). When the CPU needs to access an address in the destination address space, it first checks the TLB to see if the corresponding translation is stored. If the corresponding translation is present (referred to as a TLB hit), the CPU retrieves the translation from the TLB. If that translation is absent (referred to as a TLB miss), then retrieving the translation may involve accessing other structures with potentially higher access latency, such as page tables (often referred to as a page table walk).

A processor may invalidate a TLB entry for various reasons, e.g., when the entry becomes outdated or to make room for another translations. Invalidating an entry may increase latency for a subsequent access to the corresponding address.

### BRIEF DESCRIPTION OF THE DRAWINGS

FIG. 1 is a block diagram illustrating an example of a processor configured to lock a translation lookaside buffer (TLB) entry based on an instruction, according to some embodiments.

FIG. 2 is a block diagram illustrating an example processor with read control circuitry and aggregation control circuitry, according to some embodiments.

FIGS. 3A-B are diagrams illustrating example aggregation of TLB translations, according to some embodiments.

FIG. 4 is a block diagram illustrating example aggregation control circuitry configured to perform multiple aggregation checks, according to some embodiments.

FIG. 5A is a diagram illustrating example fields of a TLB pre-translate instruction, according to some embodiments.

FIG. 5B is a diagram illustrating example fields maintained by TLB pre-translate status circuitry, according to some embodiments.

FIG. 5C is a diagram illustrating example fields maintained by lock control circuitry, according to some embodiments.

FIG. 5D is a diagram illustrating example fields maintained by read control circuitry, according to some embodiments.

FIG. 5E is a diagram illustrating example fields of a TLB entry, according to some embodiments.

FIG. 6 is a flow diagram illustrating an example method for an instruction causing TLB entry locking, according to some embodiments.

FIG. 7 is a block diagram illustrating an example computing device, according to some embodiments.

FIG. 8 is a diagram illustrating example applications of disclosed systems and devices, according to some embodiments.

FIG. 9 is a block diagram illustrating an example computer-readable medium that stores circuit design information, according to some embodiments.

### DETAILED DESCRIPTION

As discussed above, TLB misses due to invalidation typically increase latency due to performing a page table walk. In disclosed embodiments, a processor may lock certain TLB entries such that those entries are not allowed to be invalidated (or are allowed to be invalidated only under certain conditions). The lock may be performed at least partially based on software control, e.g., as part of execution of an instruction.

Disclosed locking techniques may provide performance advantages in certain scenarios. For example, when a process is latency sensitive, invalidating its TLB entries (e.g., to make room for entries used by other processes) may introduce delay for subsequent translations for the latency-sensitive process. In contrast, locking TLB entries may advantageously allow the processor to provide latency guarantees, at least for certain processes or operations.

The present disclosure also provides mechanisms for: unlocking entries, invalidating locked entries, reading the lock status of entries, aggregating multiple translations for storage in a given TLB entry, and checking for various aggregation conditions before aggregating translation information.

### Overview of TLB Locking

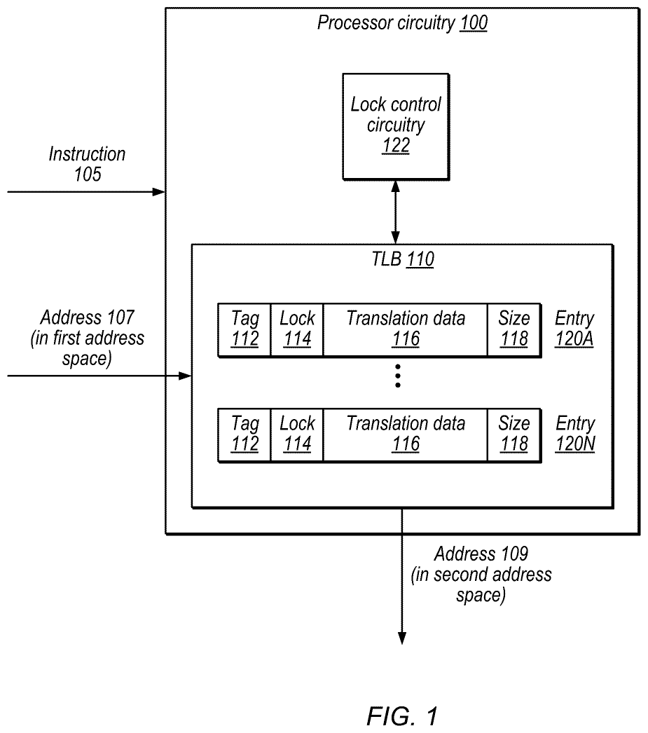

FIG. 1 is a block diagram illustrating an example of a processor configured to lock a TLB entry based on an instruction, according to some embodiments. In the illustrated embodiment, processor 100 includes TLB 110 and lock control circuitry 122. TLB 110 is coupled to lock control circuitry 122 and includes entries 120A-N.

Processor circuitry 100, in various embodiments, may include circuitry and/or microcode that is configured to perform various operations, e.g., based on executing instructions of a program. For example, as shown, processor 100 is configured to perform operations in response to instruction 105. As used herein, the term “instruction” is intended to broadly cover commands to a processor in a computer program, including without limitation: instruction set architecture (ISA)-defined instructions, interpreted instructions, compiled instructions, microcode, machine code, etc. Thus, software (e.g., the operating system (OS)) may lock a particular TLB entry by executing instruction 105. As will be discussed, instruction 105 may be a TLB pre-translate instruction that causes processor circuitry 100 to populate an entry in TLB 110 with a translation prior to encountering an instruction that needs the translation. But, other examples of instruction 105 are contemplated such as instructions that lock entries already present in the TLB. This may allow software to avoid a TLB walk for subsequent instructions that utilize the translation, reducing latency for those instructions.

In some cases, software may lock a TLB entry based on criticality of a subsequent instruction or of associated data (e.g., based on a determination that an instruction is on a critical path, a determination that data is in a region of a memory space identified as critical, etc.). More examples of determining criticality can be found in U.S. application Ser. No. 17/727,020, entitled “Criticality-Informed Caching Policies,” filed on Apr. 22, 2022.

TLB 110, in various embodiments, includes entries 120A-N for translations from a first address space to a second address space. In the illustrated embodiment, each entry 120 includes lock field 114, tag field 112, translation data field 116, and size field 118. As discussed above, TLB 110 may be configured to, in response to instruction 105, store translation information in an entry 120 that enables a translation from an address 107 in a first address space to an address 109 in a second address space. In some embodiments, the first address space is a virtual address space, and the second address space is a physical address space of a memory circuit (e.g., a memory circuit coupled to processor 100). But, in other embodiments (e.g., in the case of a TLB for a virtual machine), both the first and second address spaces are virtual. In some cases, processor 100 communicates with a memory management unit (MMU) to obtain the translation information to populate the entry.

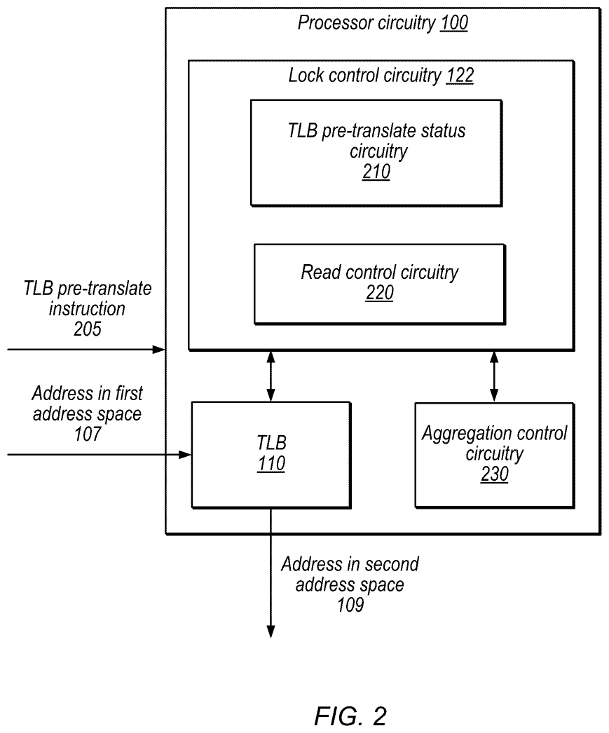

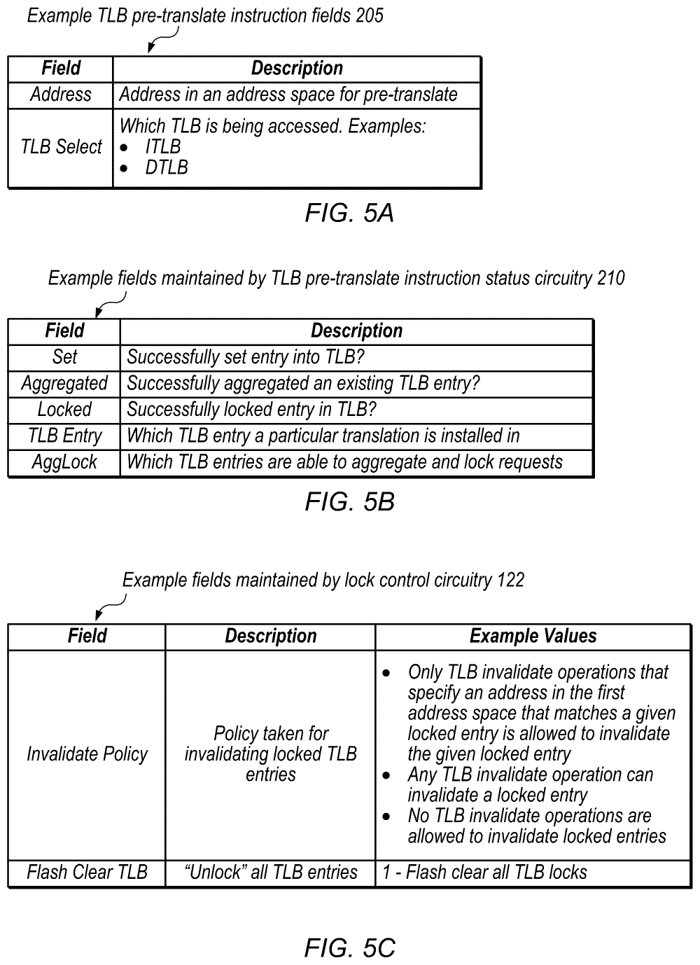

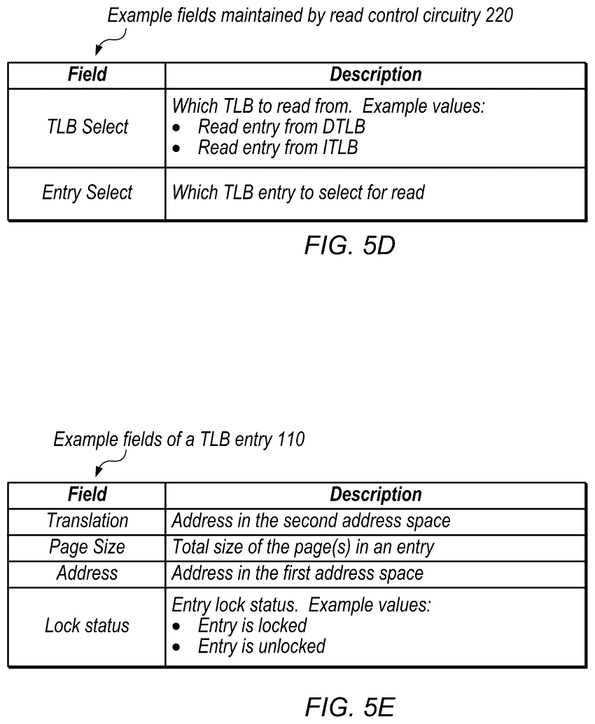

Note that tag field 112 may correspond to all or a portion of an address in the first address space while translation data field 116 may store all or a portion of an address in the second address space. In some embodiments, TLB read control circuitry is configured to provide one or more fields of a TLB entry in a software-accessible register, as is described in more detail with respect to FIGS. 2 and 5D.

Size field 118, in some embodiments, provides support for translations for variable region sizes. For example, size field 118 may enable the inclusion of translations for larger memory regions than may allowed by a TLB whose entries are of a fixed size. For example, a fixed-size TLB entry would include a translation for a fixed region size, but a variable-size TLB entry allows for translations for input addresses in larger or smaller areas of memory than the fixed size. Additionally, variable size field 118 may be used to aggregate several translations within a single TLB entry, as will be discussed in more detail with respect to FIGS. 2-4.

Note that TLB 110 may include multiple portions, one of which may have fixed-size entries and another of which may support variable-size entries. The variable-size portion may be referred to as a “sidecar” to the fixed-size portion. Therefore, in some embodiments, only a subset of entries in the overall TLB 110 may support aggregation of translations. But in other embodiments, all entries in TLB 110 are variable-size entries that support aggregation of translations.

Processor 100 may use one or more fields of TLB 110 to determine translations for memory accesses. In some cases, processor 100 first determines whether a translation for a particular input address exists in the TLB. In one example embodiment, processor 100 uses size field 118 and tag field 112 to determine whether the input address is within the memory region associated with the TLB entry. If the input address is within the memory region (signifying a TLB hit), processor 100 may then the translation data field 116 (e.g., a physical page number offset) of the selected entry to determine the input address's translation and perform the memory access.

Lock control circuitry 122, in some embodiments, is configured to control the lock fields 114 of TLB entries. For example, lock control circuitry 122 may set an entry to locked based on a pre-translate instruction that populates the entry, at least under certain conditions. In some embodiments, a lock indication causes processor 100 to maintain, notwithstanding an invalidate command corresponding to the locked entry, the locked entry in a valid state in TLB 110. Locking entries 120 of TLB 110 may advantageously prevent TLB misses for those entries. Processor 100 may thus be able to guarantee an upper latency bound on a set of operations that utilize one or more locked TLB entries (in contrast to operations that may miss in the TLB and require a table walk, which may vary in latency).

It is noted that the number of components of processor circuitry 100 (and the number of subcomponents for those shown in FIG. 1, such as within TLB 110) may vary between embodiments. Accordingly, there may be more or fewer of each component or subcomponent than the number shown in FIG. 1. Further, processor 100 may encompass discrete microprocessors, processors and/or microprocessors integrated into multichip module implementations, processors implemented as multiple integrated circuits, etc.

### Example Lock Control and Translation Aggregation Techniques

FIG. 2 is a block diagram illustrating an example processor with read control circuitry and aggregation control circuitry, according to some embodiments. In particular, FIG. 2 shows processor circuitry 100 further including aggregation control circuitry 230.

Lock control circuitry 122, in the illustrated embodiment, includes TLB pre-translate status circuitry 210 and read control circuitry 220. In the illustrated example, lock control circuitry 122 is configured to perform the TLB pre-translate instruction 205 by locking an entry in TLB 110.

TLB pre-translate status circuitry 210, in the illustrated embodiment, is configured to maintain information describing the status of TLB pre-translate instruction 205. In some embodiments, TLB pre-translate status circuitry 210 maintains that information in a software-readable register. This may allow an operating system executing on processor 100 to inquire the status of pre-translate instruction 205. Example fields maintained by TLB pre-translate status circuitry 210 are described in more detail with reference to FIG. 5B.

Read control circuitry 220, in the illustrated embodiment, is configured to read data of one or more entries 120 in TLB 110. To access data in a given entry 120, processor 100 may, in some embodiments, first write to a control register of read control circuitry 220 to specify the given entry 120 to be read. For example, processor 100 may write an identifier of the particular entry at the control register of read control circuitry 220. Then, software (e.g., debugging software, operating systems, etc.) may read a software-accessible control register to retrieve values at various fields (e.g., tag field 112, lock field 114) of the particular entry specified at circuitry 220 . . . . Example fields of control register of circuitry 220 are described in more detail with reference to FIG. 5D.

Generally, processor 100 and lock control circuitry 122 may perform the following operations based on execution of TLB pre-translate instruction 205. Processor 100 may decode pre-translate instruction 205 and determine that it is a pre-translate instruction that specifies to store a translation for an address range (e.g., address 107) in an entry of TLB 110. Processor 100 then determines information usable to determine target addresses (e.g., address 109), e.g., by performing a page table walk and store, stores translation information in the appropriate entry. Lock control circuitry 122 then locks the newly populated entry (e.g., by modifying lock field 114). Processor circuitry 100 may check TLB pre-translate status circuitry 210 to check for status on completion (e.g., to determine if aggregation occurred, as discussed in detail below).

As discussed above, a lock field may prevent a TLB entry from being invalidated when processor 100 would normally have invalidated the entry. In some embodiments, lock control circuitry 122 is configured to determine whether to invalidate a given entry based on: the type of invalidate operation, the lock status of the entry, and an invalidate policy maintained by lock control circuitry 122. Example control fields relating to a lock policy are discussed below with reference to FIG. 5C. For example, one invalidate policy may prevent all invalidation operations of a locked entry while another invalidate policy may allow invalidation of a locked entry only if the invalidate operation includes a specific address that invalidates the locked entry (e.g., in contrast to a less-specific invalidate operation corresponding to multiple entries).

Generally, it may be undesirable to lock a large number of entries in the TLB, e.g., because this may block allocation of other entries, increasing latency for accesses that would have hit in the TLB if a prior transaction to the same address range was not able to allocate a TLB entry. In some embodiments, aggregating translation information in a given TLB entry may mitigate or avoid this issue.

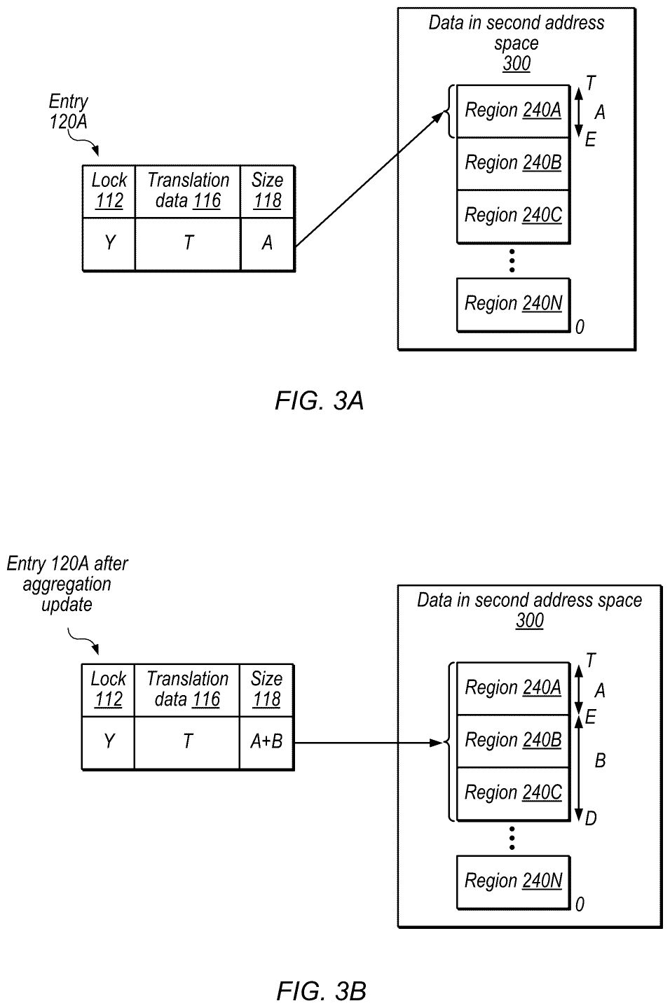

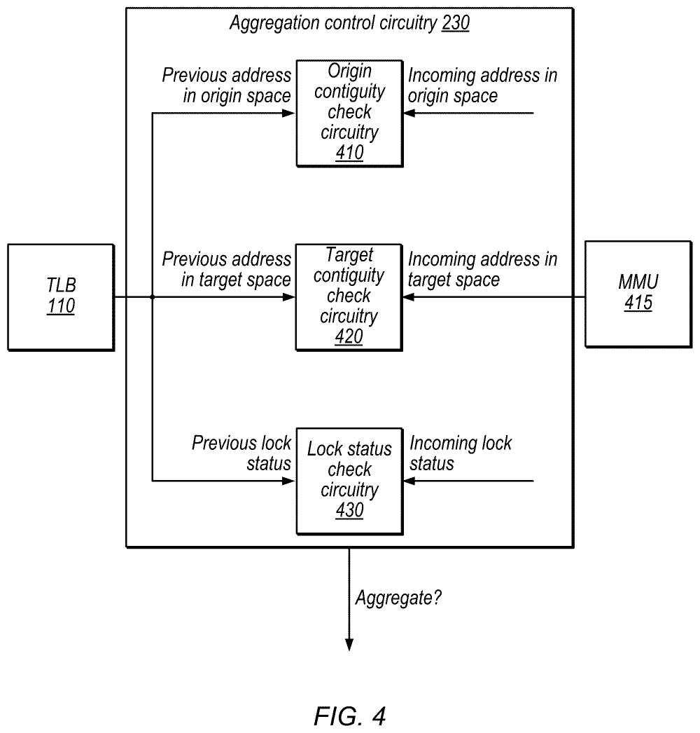

In some scenarios, aggregation control circuitry 230 is configured to aggregate translation information in a single TLB entry. The inventors observed that TLB entries accessed by a particular process often store translations for contiguous regions of memory (e.g., a memory region whose high address is one addressable location lower than the low address of another region). In these scenarios, aggregation control circuitry 230 may aggregate translation information for the contiguous regions in a single TLB entry, assuming certain conditions are satisfied. For example, for a variable-size TLB entry, aggregation control circuitry may adjust size field 118 of the entry to reflect the aggregation, as is discussed in more detail with reference to FIGS. 3A-B. Example aggregation criteria are discussed in more detail with reference to FIG. 4

Aggregation of TLB entries may free up entries in the TLB that would be otherwise locked for storing incoming translations and thus advantageously reduce the number of TLB misses and latency.

FIGS. 3A-B are diagrams illustrating example aggregation of translation lookaside buffer translations, according to some embodiments. In the illustrated example, entry 120A describes a region 240A of memory in the second address space 300. More specifically, translation data field 116 and size field 118 specify the base address and size of region 240A, in some embodiments. Moreover, the value at lock field 114 value (Y) indicates that the entry is locked.

As noted, processor 100 may modify previously-stored data in entry 120A to aggregate, in the entry, translation information for multiple regions 240 of second address space 300. In that case, entry 120A may store translation information for both the previously-stored translation and an incoming translation, as opposed to storing two separate translations in two entries. In some cases, the incoming translation may be generated by processor 100 in response to a memory access instruction, a pre-translate instruction 205, etc.

FIG. 3B shows an example aggregation that modifies the TLB entry of FIG. 3A. In this example, the aggregation is between the existing translation of FIG. 3A for region 240A having base address T and size A, and an incoming translation for regions 240B-C having a base address A+T and size B, making them contiguous with region 240A. Thus, entry 120A after the aggregation update, as shown, is for a region in the second address space that combines regions 240A and 240B-C of the existing and incoming translations. In this instance, the entry stores the same base address (T) as the first translation at translation data field 116, but stores a modified size field value of A+B corresponding to the size of the summed region sizes. This aggregation allows for a translation for all three regions without using an additional TLB entry for regions 240B-C.

Note that aggregation may modify fields of entry 120A differently depending on the layout of second address space 300. For example, addresses in second address space 300 may be ascending, such that the base address of entry 120A is initially E. Accordingly, an aggregation of both memory regions depicted in FIG. 3B would change entry 120A by changing the value of translation data field 116 from E to D and updating the value of size field 118 from A to A+B, in those embodiments.

In some embodiments, control circuitry may partially invalidate an aggregated entry. For example, the processor may perform an invalidate operation that specifies only a portion of the address range of an aggregated entry. Control circuitry may modify one or more fields of the aggregated TLB entry rather than invalidating the whole entry in this scenario, e.g., such that the specified portion in the second address space is removed from the entry, but translations for other portions of the address range remain valid. For example, if an invalidation is for region 240C (but not regions 240A-B), then entry 120A may be modified to include a translation for regions 240A-B, but not for region 240C. As one specific example, aggregation control circuitry 230 may perform the partial invalidation by subtracting the size field 118 by the size of region 240C being invalidated.

In some embodiments, aggregation control circuitry 230 may consider one or more aggregation criteria when merging entries as shown in FIG. 3A-B. For example, aggregation control circuitry 230 may check whether the incoming translation and the existing translation in entry 120A share the same lock status. This may ensure that locked entries are not aggregated with unlocked entries. Other criteria to determine whether to aggregate in a TLB entry are described in more detail with respect to FIG. 4.

FIG. 4 is a block diagram illustrating example aggregation control circuitry configured to perform multiple aggregation checks, according to some embodiments. As shown, aggregation is conditioned on checking three example aggregation criteria evaluated using origin contiguity check circuitry 410, target contiguity check circuitry 420, and lock status check circuitry 430.

Origin contiguity check circuitry 410, in various embodiments, is configured to determine contiguity of previous and existing memory regions in the origin space. In some embodiments, circuitry 410 includes an adder circuit that computes a sum of the previous origin-space address and the previous page size (e.g., both retrieved from TLB 110 using read control circuitry 220). A comparator circuit may then compare the sum against the incoming origin-space address. If the inputs to the comparator match, the origin space regions of previous and incoming addresses are contiguous, and the first aggregation criterion is met, in this example.

Target contiguity check circuitry 420, in various embodiments, is configured to determine contiguity of previous and existing memory regions in the target space. As shown, this contiguity is determined using target space addresses for both the previous translation in TLB 110 (e.g., retrieved via read control circuitry 220) and for the new translation received from MMU 415 (e.g., retrieved via a table walk in response to instruction 105). In some embodiments, target contiguity check circuitry 420 uses adder circuitry and comparator circuitry similarly to origin contiguity check circuitry 410 to determine the contiguity of incoming and previous translated regions in the target address space. If circuitry 420 determines contiguity, then the second aggregation criterion is met. Note that FIGS. 3A-B, discussed above, show an example aggregation involving contiguous memory regions in the target space.

Lock status check circuitry 430, in various embodiments, compares the previous lock status of a previously-stored entry against the lock status of an incoming translation. In some embodiments, lock status check circuitry includes a comparator circuit (e.g., an XNOR gate) that outputs a high signal when it detects that the previous and incoming lock status values are equal. If the lock statuses are equal, then the third aggregation criterion is met.

In some embodiments, respective output signals of circuitry 410, 420, and 430 are input into an AND gate, which outputs the final decision to aggregate the previous translation and the incoming translation in the previous translation's TLB entry. But in other embodiments, additional criteria may be used to evaluate whether a particular entry can be aggregated, illustrated criteria may be omitted, or both. For example, additional permission check circuitry may compare permissions bits of previously stored and incoming translation information. This may, in some cases, ensure that data in the entry is not modified with translation information that is not appropriate at the entry's current permission level. In some embodiments, aggregation control circuitry 230 may simultaneously read TLB 110 for multiple previously-stored TLB entry values, e.g., utilizing check circuitry coupled to multiple entries.

### Example Instruction, Control, and TLB Fields

The following figures show example fields included in example instructions, maintained by control circuitry, or included in a TLB entry, according to some embodiments. Various fields described below may be used in conjunction with the techniques discussed above.

FIG. 5A is a diagram illustrating example fields of a TLB pre-translate instruction according to some embodiments. The address field, in the illustrated embodiment, specifies all or a portion of an address in the first address space for which translation information is to be stored in the TLB. The TLB Select field indicates which TLB (e.g., instruction TLB, data TLB) will include the translation information, in embodiments with multiple TLBs. While FIG. 5A describes fields of a TLB pre-translate instruction (e.g., pre-translate instruction 205), instruction 105 (or other instructions similar to instruction 105) may have similar or different fields.

FIG. 5B is a diagram illustrating example fields maintained by TLB pre-translate status circuitry 210, according to some embodiments. The set field indicates whether the previous TLB pre-translate instruction (e.g., instruction 205) has successfully set and locked an entry into the TLB. The aggregated field indicates whether a given TLB entry includes aggregated translation information. The locked field indicates whether a given TLB entry is locked. The TLB entry field indicates which TLB entry a particular translation is installed in (e.g., encoded as an index, in some embodiments). The AggLock field indicates which TLB entries are able to aggregate and lock requests (e.g., TLB entries that include lock field 114 and size field 118) in embodiments in which some entries are not configured to be locked, are not configured to store aggregated translation information, or both. Software or hardware may access these fields to obtain information regarding previous instructions.

FIG. 5C is a diagram illustrating example fields maintained by lock control circuitry, according to some embodiments. The invalidate policy field, in some embodiments, dictates interaction between different types of invalidate operations and locked TLB entries. Under the first example policy, a TLB invalidate operation can invalidate a locked entry only if the operation specifies an address in the first address space that corresponds to given locked entry. Under the second example policy, any TLB invalidate operation can invalidate a locked entry, effectively disabling the lock feature. Under the third example policy, no TLB invalidate operation can invalidate locked entries. Note that these policies are included for purposes of illustration, but are not intended to limit the scope of the present disclosure. Other policies may be implemented in other embodiments, e.g., to specify other conditions on invalidation of locked entries.

The flash clear TLB field, when toggled (by software or hardware), causes the control circuitry to unlock multiple locked entries in the TLB circuitry (e.g., all entries). The flash clear TLB field may affect a particular TLB, such as the ITLB.

FIG. 5D is a diagram illustrating example fields maintained by read control circuitry, according to some embodiments. These fields may be maintained in a control register, which may be written to access various TLB entry information (e.g., one or more fields of FIG. 5E). Software or hardware may use these fields to select which particular TLB entry to access. The TLB Select field specifies which TLB is to be read, while the Entry Select field specifies which particular entry of the selected TLB is to be read.

FIG. 5E is a diagram illustrating example fields of a TLB entry, according to some embodiments. Note that these fields are examples of tag 112, translation data 116, size 118, and lock 114 fields of FIG. 1. The translation field, in the illustrated embodiment, is all or a portion of an address in the second address space. The address field, in the illustrated embodiment, is all or a portion of an address in the first address space. The page size, in the illustrated embodiment, describes the size of the memory region that the translation corresponds to. In some embodiments, the page size is used to aggregate translations, as discussed above. The lock status, in the illustrated embodiment, describes whether the particular entry is locked and may be used during aggregation or invalidation, as described above.

Fields of FIGS. 5E and 5D may be used by software to manage the TLB in multiple scenarios. Consider a context switch that flushes all entries of a TLB. In that case, software may, during the context switch, back up a given TLB entry 120 by writing to a control register of circuitry 220, reading entries of TLB 110, and saving fields of read entries in a software data structure (e.g., a stack). When a context restore occurs, the stored TLB data may be used to restore values of the TLB to its prior state (e.g., by popping data from the stack). Note that only a portion of the TLB entry information may be saved and restored for only a portion of entries used by a given process (e.g., only for locked entries), for only a portion of the fields of a given entry, or for both portions.

### Example Method

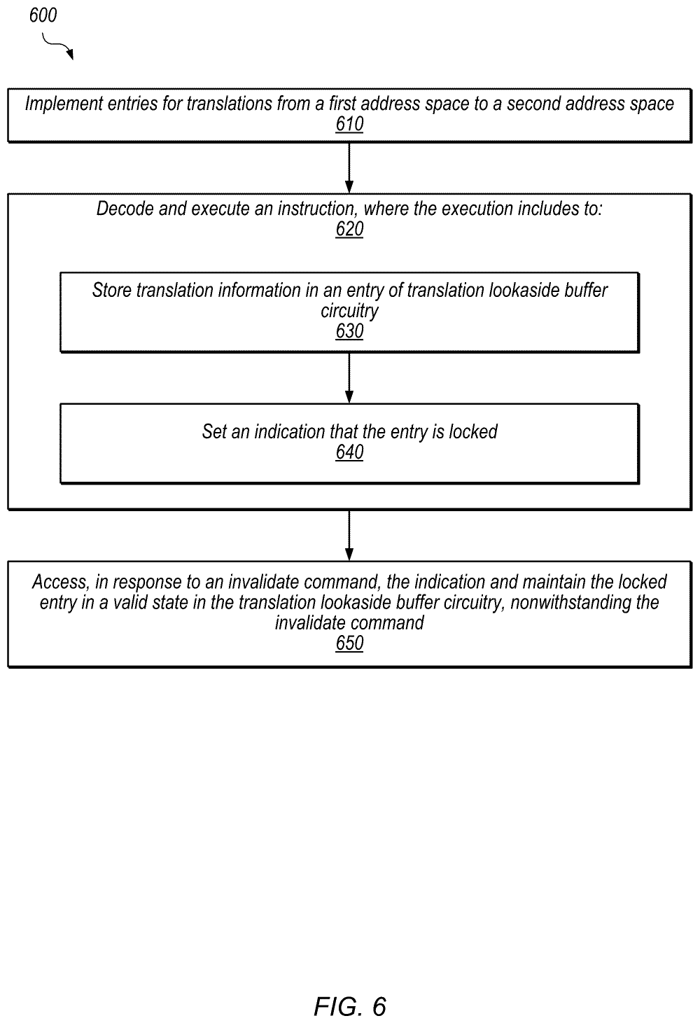

FIG. 6 is a flow diagram illustrating an example method for an instruction causing a TLB entry lock. Method 600 shown in FIG. 6 may be used in conjunction with any of the computer circuitry, systems, devices, elements, or components disclosed herein, among others. In various embodiments, some of the method elements shown may be performed concurrently, in a different order than shown, or may be omitted. Additional method elements may also be performed as desired.

At 610, in the illustrated embodiment, translation lookaside buffer circuitry (e.g., TLB 110) implements entries (e.g., entries 120) for translations from a first address space to a second address space (e.g., translation from address 107 to address 109). In some embodiments, the first address space is a virtual address space, and the second address space is a physical address space of a memory circuit of the apparatus. In some embodiments, the TLB circuitry includes a first set of entries that support translations for variable region sizes in the second address space, and a second set of entries that support translations for fixed region sizes in the second address space.

At 620, in the illustrated embodiment, processor circuitry (e.g., processor 100) decodes and executes an instruction (e.g., instruction 105). In some embodiments, an apparatus generates the instruction based on a criticality of data in the first address space, where the data is addressed by the translation information. In some embodiments, the instruction is a TLB pre-translate instruction (e.g., instruction 205).

At 630, in the illustrated embodiment, the execution of the instruction includes storing (e.g., by the processor) translation information in an entry of TLB circuitry.

At 640, in the illustrated embodiment, the execution of the instruction includes setting, by lock control circuitry (e.g., lock control circuitry 122), an indication that the entry is locked (e.g., in lock field 114). In some embodiments, the set indication that the entry is locked provides a guarantee that latency for one or more operation that access the locked entry does not exceed a threshold latency value. In some embodiments, read control circuitry provides information that indicates lock status of one or more entries in the TLB circuitry in a software-accessible control register. In some embodiments, control circuitry unlocks multiple locked entries in the translation lookaside buffer circuitry based on software input.

At 650, in the illustrated embodiment, the processor accesses, in response to an invalidate command, the indication and maintains the entry in a valid state in the translation lookaside buffer circuitry notwithstanding the invalidate command. The processor circuitry may, in response to an invalidate operation with an address in the first address space that corresponds to a first portion of a region in the second address space corresponding to the locked entry, modify data in the entry to provide a translation for a second portion of the region and not the first portion of the region.

In some embodiments, the maintenance of the locked entry in a valid state in the translation lookaside buffer circuitry is further based on a locked-entry-invalidation policy currently imposed by the apparatus. The processor circuitry may support at least a first policy under which no invalidate operations are allowed to invalidate locked entries, and a second policy under which only invalidate operations that specify an address in the first address space that matches a given locked entry is allowed to invalidate the given locked entry.

In some embodiments, the processor circuitry modifies previously-stored data in the entry to aggregate, in the entry, translation information for multiple regions of the second address space. The modification of the previously-stored data may include modification of a page size field of the entry. Processor circuitry may perform the aggregation in response to verifying one or more aggregation criteria. The aggregation criteria may include contiguity criteria, such as a first contiguity criterion that the translation information corresponds to a first set of addresses in the first address space that is contiguous with a second set of addresses in the first address space associated with the instruction, and a second contiguity criterion that the translation information corresponds to a first set of addresses in the second address space that is contiguous with a second set of addresses in the second address space associated with the instruction.

The concept of a processor “pipeline” is well understood, and refers to the concept of splitting the “work” a processor performs on instructions into multiple stages. In some embodiments, instruction decode, dispatch, execution (i.e., performance), and retirement may be examples of different pipeline stages. Many different pipeline architectures are possible with varying orderings of elements/portions. Various pipeline stages perform such steps on an instruction during one or more processor clock cycles, then pass the instruction or operations associated with the instruction on to other stages for further processing.

### Example Device

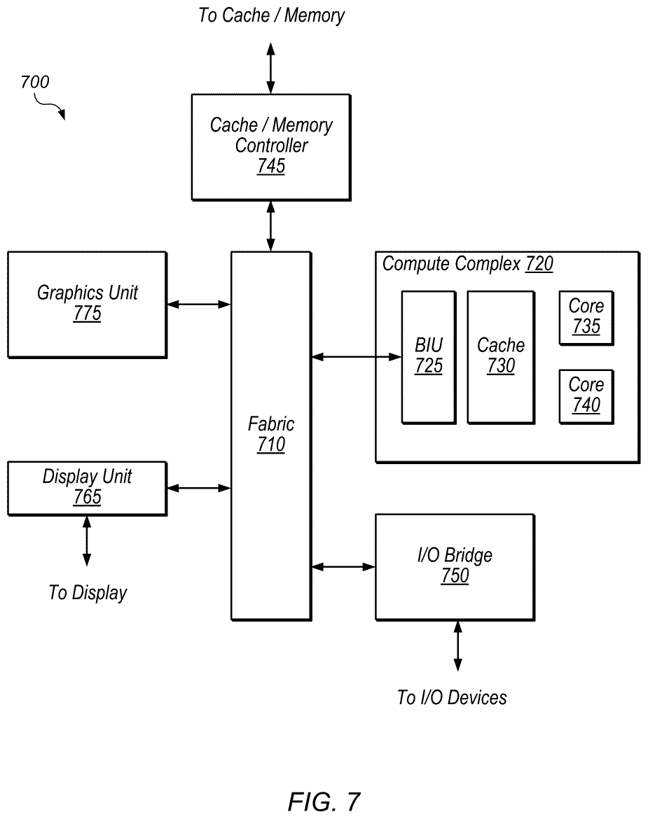

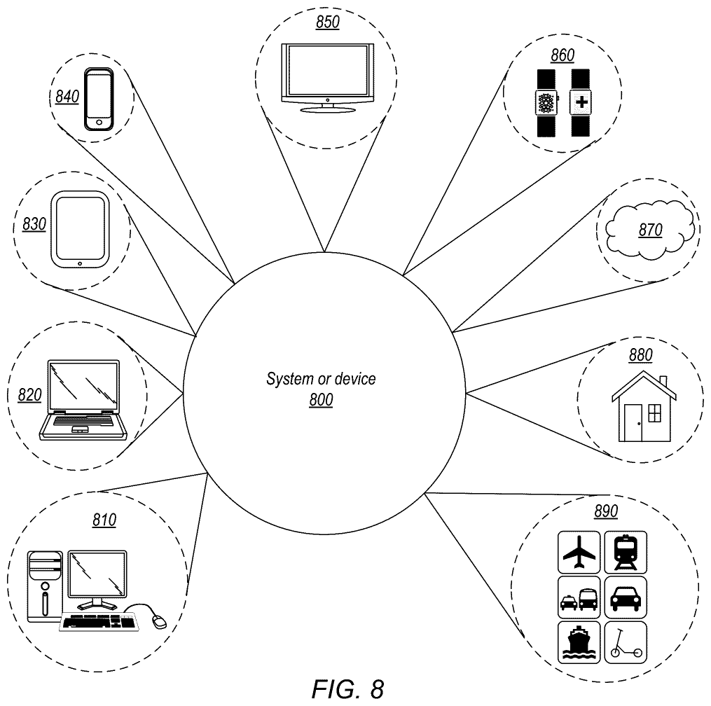

Referring now to FIG. 7, a block diagram illustrating an example embodiment of a device 700 is shown. In some embodiments, device 700 may implement functionality of processor circuitry 100. In some embodiments, elements of device 700 may be included within a system on a chip. In some embodiments, device 700 may be included in a mobile device, which may be battery-powered. Therefore, power consumption by device 700 may be an important design consideration. In the illustrated embodiment, device 700 includes fabric 710, compute complex 720 input/output (I/O) bridge 750, cache/memory controller 745, graphics unit 775, and display unit 765. In some embodiments, device 700 may include other components (not shown) in addition to or in place of the illustrated components, such as video processor encoders and decoders, image processing or recognition elements, computer vision elements, etc.

Fabric 710 may include various interconnects, buses, MUX's, controllers, etc., and may be configured to facilitate communication between various elements of device 700. In some embodiments, portions of fabric 710 may be configured to implement various different communication protocols. In other embodiments, fabric 710 may implement a single communication protocol and elements coupled to fabric 710 may convert from the single communication protocol to other communication protocols internally.

In the illustrated embodiment, compute complex 720 includes bus interface unit (BIU) 725, cache 730, and cores 735 and 740. In various embodiments, compute complex 720 may include various numbers of processors, processor cores and caches. For example, compute complex 720 may include 1, 2, or 4 processor cores, or any other suitable number. In one embodiment, cache 730 is a set associative L2 cache. In some embodiments, cores 735 and 740 may include internal instruction and data caches. In some embodiments, a coherency unit (not shown) in fabric 710, cache 730, or elsewhere in device 700 may be configured to maintain coherency between various caches of device 700. BIU 725 may be configured to manage communication between compute complex 720 and other elements of device 700. Processor cores such as cores 735 and 740 may be configured to execute instructions of a particular instruction set architecture (ISA) which may include operating system instructions and user application instructions. These instructions may be stored in computer readable medium such as a memory coupled to memory controller 745 discussed below.

As used herein, the term “coupled to” may indicate one or more connections between elements, and a coupling may include intervening elements. For example, in FIG. 7, graphics unit 775 may be described as “coupled to” a memory through fabric 710 and cache/memory controller 745. In contrast, in the illustrated embodiment of FIG. 7, graphics unit 775 is “directly coupled” to fabric 710 because there are no intervening elements.

Cache/memory controller 745 may be configured to manage transfer of data between fabric 710 and one or more caches and memories. For example, cache/memory controller 745 may be coupled to an L3 cache, which may in turn be coupled to a system memory. In other embodiments, cache/memory controller 745 may be directly coupled to a memory. In some embodiments, cache/memory controller 745 may include one or more internal caches. Memory coupled to controller 745 may be any type of volatile memory, such as dynamic random access memory (DRAM), synchronous DRAM (SDRAM), double data rate (DDR, DDR2, DDR3, etc.) SDRAM (including mobile versions of the SDRAMs such as mDDR3, etc., and/or low power versions of the SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to controller 745 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 720 to cause the computing device to perform functionality described herein.

Graphics unit 775 may include one or more processors, e.g., one or more graphics processing units (GPUs). Graphics unit 775 may receive graphics-oriented instructions, such as OPENGL®, Metal®, or DIRECT3D® instructions, for example. Graphics unit 775 may execute specialized GPU instructions or perform other operations based on the received graphics-oriented instructions. Graphics unit 775 may generally be configured to process large blocks of data in parallel and may build images in a frame buffer for output to a display, which may be included in the device or may be a separate device. Graphics unit 775 may include transform, lighting, triangle, and rendering engines in one or more graphics processing pipelines. Graphics unit 775 may output pixel information for display images. Graphics unit 775, in various embodiments, may include programmable shader circuitry which may include highly parallel execution cores configured to execute graphics programs, which may include pixel tasks, vertex tasks, and compute tasks (which may or may not be graphics-related).

Display unit 765 may be configured to read data from a frame buffer and provide a stream of pixel values for display. Display unit 765 may be configured as a display pipeline in some embodiments. Additionally, display unit 765 may be configured to blend multiple frames to produce an output frame. Further, display unit 765 may include one or more interfaces (e.g., MIPI® or embedded display port (eDP)) for coupling to a user display (e.g., a touchscreen or an external display).

I/O bridge 750 may include various elements configured to implement: universal serial bus (USB) communications, security, audio, and low-power always-on functionality, for example. I/O bridge 750 may also include interfaces such as pulse-width modulation (PWM), general-purpose input/output (GPIO), serial peripheral interface (SPI), and inter-integrated circuit (I2C), for example. Various types of peripherals and devices may be coupled to device 700 via I/O bridge 750.

In some embodiments, device 700 includes network interface circuitry (not explicitly shown), which may be connected to fabric 710 or I/O bridge 750. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 700 with connectivity to various types of other devices and networks.

### Example Applications

Turning now to FIG. 8, various types of systems that may include any of the circuits, devices, or system discussed above. System or device 800, which may incorporate or otherwise utilize one or more of the techniques described herein, may be utilized in a wide range of areas. For example, system or device 800 may be utilized as part of the hardware of systems such as a desktop computer 810, laptop computer 820, tablet computer 830, cellular or mobile phone 840, or television 850 (or set-top box coupled to a television).

Similarly, disclosed elements may be utilized in a wearable device 860, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 800 may also be used in various other contexts. For example, system or device 800 may be utilized in the context of a server computer system, such as a dedicated server or on shared hardware that implements a cloud-based service 870. Still further, system or device 800 may be implemented in a wide range of specialized everyday devices, including devices 880 commonly found in the home such as refrigerators, thermostats, security cameras, etc. The interconnection of such devices is often referred to as the “Internet of Things” (IoT). Elements may also be implemented in various modes of transportation. For example, system or device 800 could be employed in the control systems, guidance systems, entertainment systems, etc. of various types of vehicles 890.

The applications illustrated in FIG. 8 are merely exemplary and are not intended to limit the potential future applications of disclosed systems or devices. Other example applications include, without limitation: portable gaming devices, music players, data storage devices, unmanned aerial vehicles, etc.

### Example Computer-Readable Medium

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as: design simulation, design synthesis, circuit fabrication, etc.

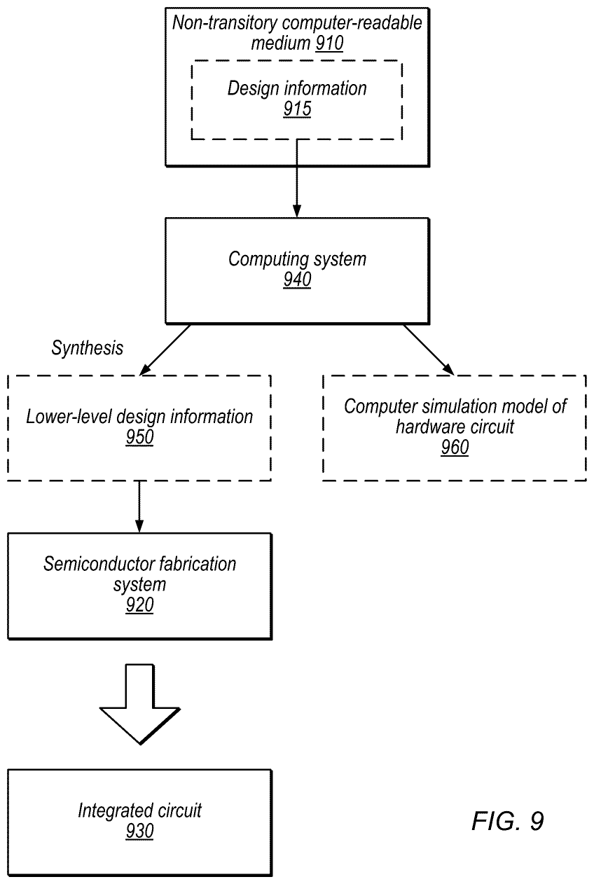

FIG. 9 is a block diagram illustrating an example non-transitory computer-readable storage medium that stores circuit design information, according to some embodiments. In the illustrated embodiment, computing system 940 is configured to process the design information. This may include executing instructions included in the design information, interpreting instructions included in the design information, compiling, transforming, or otherwise updating the design information, etc. Therefore, the design information controls computing system 940 (e.g., by programming computing system 940) to perform various operations discussed below, in some embodiments.

In the illustrated example, computing system 940 processes the design information to generate both a computer simulation model of a hardware circuit 960 and lower-level design information 950. In other embodiments, computing system 940 may generate only one of these outputs, may generate other outputs based on the design information, or both. Regarding the computing simulation, computing system 940 may execute instructions of a hardware description language that includes register transfer level (RTL) code, behavioral code, structural code, or some combination thereof. The simulation model may perform the functionality specified by the design information, facilitate verification of the functional correctness of the hardware design, generate power consumption estimates, generate timing estimates, etc.

In the illustrated example, computing system 940 also processes the design information to generate lower-level design information 950 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on lower-level design information 950 (potentially among other inputs), semiconductor fabrication system 920 is configured to fabricate an integrated circuit 930 (which may correspond to functionality of the simulation model 960). Note that computing system 940 may generate different simulation models based on design information at various levels of description, including information 950, 915, and so on. The data representing design information 950 and model 960 may be stored on medium 910 or on one or more other media.

In some embodiments, the lower-level design information 950 controls (e.g., programs) the semiconductor fabrication system 920 to fabricate the integrated circuit 930. Thus, when processed by the fabrication system, the design information may program the fabrication system to fabricate a circuit that includes various circuitry disclosed herein.

Non-transitory computer-readable storage medium 910, may comprise any of various appropriate types of memory devices or storage devices. Non-transitory computer-readable storage medium 910 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. Non-transitory computer-readable storage medium 910 may include other types of non-transitory memory as well or combinations thereof. Accordingly, non-transitory computer-readable storage medium 910 may include two or more memory media; such media may reside in different locations—for example, in different computer systems that are connected over a network.

Design information 915 may be specified using any of various appropriate computer languages, including hardware description languages such as, without limitation: VHDL, Verilog, SystemC, System Verilog, RHDL, M, MyHDL, etc. The format of various design information may be recognized by one or more applications executed by computing system 940, semiconductor fabrication system 920, or both. In some embodiments, design information may also include one or more cell libraries that specify the synthesis, layout, or both of integrated circuit 930. In some embodiments, the design information is specified in whole or in part in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 930 may, in various embodiments, include one or more custom macrocells, such as memories, analog or mixed-signal circuits, and the like. In such cases, design information may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 920 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 920 may also be configured to perform various testing of fabricated circuits for correct operation.

In various embodiments, integrated circuit 930 and model 960 are configured to operate according to a circuit design specified by design information 915, which may include performing any of the functionality described herein. For example, integrated circuit 930 may include any of various elements shown in FIGS. 1, 2, 4, and 7. Further, integrated circuit 930 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model” does not imply that the instructions must be executed in order for the element to be met, but rather specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by the design information. The different circuit implementations may affect the performance, area, power consumption, etc. of a given design (potentially with tradeoffs between different design goals), but the logical function does not vary among the different circuit implementations of the same circuit design.

In some embodiments, the instructions included in the design information instructions provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information. The lower-level design information may program fabrication system 920 to fabricate integrated circuit 930.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112 (f) for that claim element. Should Applicant wish to invoke Section 112 (f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed:

1. An apparatus, comprising:
processor circuitry that includes:
lock control circuitry; and
translation lookaside buffer circuitry that implements entries for translations from a first address space to a second address space;
wherein:
the processor circuitry is configured to decode and execute an instruction, wherein the execution includes to:
store translation information in an entry of the translation lookaside buffer circuitry; and
set, by the lock control circuitry, an indication that the entry is locked; and
the processor circuitry is configured to, in response to an invalidate command corresponding to the locked entry, access the indication and maintain the locked entry in a valid state in the translation lookaside buffer circuitry, notwithstanding the invalidate command, based on the indication.

2. The apparatus of claim 1, wherein the instruction is a translation lookaside buffer pre-translate instruction.

3. The apparatus of claim 1, wherein:
the processor circuitry is configured to provide a guarantee, based on the set indication that the entry is locked, that latency for one or more operations that access the locked entry does not exceed a threshold latency value.

4. The apparatus of claim 1, further comprising:
read control circuitry configured to provide information that indicates lock status of one or more entries in the translation lookaside buffer circuitry in a software-accessible control register.

5. The apparatus of claim 1, wherein to store the translation information in the entry, the processor circuitry is configured to modify previously-stored data in the entry to aggregate, in the entry, translation information for multiple regions of the second address space.

6. The apparatus of claim 5, wherein modification of the previously-stored data includes modification of a page size field of the entry.

7. The apparatus of claim 5, wherein the processor circuitry is configured to perform the aggregation in response to verifying one or more aggregation criteria.

8. The apparatus of claim 7, wherein the one or more aggregation criteria include contiguity criteria, including:
a first contiguity criterion that the translation information corresponds to a first set of addresses in the first address space that is contiguous with a second set of addresses in the first address space associated with the instruction; and
a second contiguity criterion that the translation information corresponds to a first set of addresses in the second address space that is contiguous with a second set of addresses in the second address space associated with the instruction.

9. The apparatus of claim 5, wherein the translation lookaside buffer circuitry includes:
a first set of entries, including the entry, that support translations for variable region sizes in the second address space; and
a second set of entries that support translations for fixed region sizes in the second address space.

10. The apparatus of claim 1, wherein the maintenance of the locked entry in a valid state in the translation lookaside buffer circuitry is further based on a locked-entry-invalidation policy currently imposed by the apparatus.

11. The apparatus of claim 10, wherein the processor circuitry supports at least the following locked-entry-invalidation policies:
a first policy under which no invalidate operations are allowed to invalidate locked entries; and
a second policy under which only invalidate operations that specify an address in the first address space that matches a given locked entry is allowed to invalidate the given locked entry.

12. The apparatus of claim 1, wherein the processor circuitry is further configured to, in response to an invalidate operation with an address in the first address space that corresponds to a first portion of a region in the second address space corresponding to the locked entry, modify data in the entry to provide a translation for a second portion of the region and not the first portion of the region.

13. The apparatus of claim 1, further comprising control circuitry configured to unlock multiple locked entries in the translation lookaside buffer circuitry based on software input.

14. The apparatus of claim 1, wherein the first address space is a virtual address space, and the second address space is a physical address space of a memory circuit of the apparatus.

15. The apparatus of claim 1, wherein the apparatus is further configured to generate the instruction based on a criticality of data in the first address space, where the data is addressed by the translation information.

16. A non-transitory computer-readable medium having an instruction stored thereon that is executable by a computing device to perform operations comprising:
setting, in an entry of translation lookaside buffer circuitry, translation information for translations from a first address space to a second address space; and
setting an indication that the entry is locked, such that, in response to an invalidate command corresponding to the locked entry, the computing device maintains the locked entry in a valid state in the translation lookaside buffer circuitry, notwithstanding the invalidate command, based on the indication.

17. The non-transitory computer-readable medium of claim 16, wherein the instruction is a translation lookaside buffer pre-translate instruction.

18. The non-transitory computer-readable medium of claim 16, wherein the setting further comprises accessing, using a software-accessible control register, the indication that the entry is locked.

19. The non-transitory computer-readable medium of claim 16, wherein the operations further comprise:
modifying set translation information to aggregate, in the entry, translation information for multiple regions of the second address space.

20. A method, comprising:
decoding and executing, by a computing device, an instruction, wherein the executing includes:
storing, in an entry of a translation lookaside buffer circuitry, translation information for translations from a first address space to a second address space;
setting, by lock control circuitry, an indication that the entry is locked; and
in response to an invalidate command corresponding to the locked entry, accessing the indication and maintaining the locked entry in a valid state in the translation lookaside buffer circuitry, notwithstanding the invalidate command, based on the indication.

21. The method of claim 20, wherein the instruction is a translation lookaside buffer pre-translate instruction.

22. The method of claim 20, wherein the storing further comprises modifying previously stored data in the entry to aggregate translation information for multiple regions of the second address space.

23. The method of claim 20, wherein the maintenance of the locked entry in a valid state in the translation lookaside buffer circuitry is further based on a locked-entry-invalidation policy currently imposed by the computing device.
